(19) United States
(12) Patent Application Publication
(10) Pub. No.: US 2014/0300321 A1
(43) Pub. Date: Oct. 9, 2014

(54) METHOD FOR CONTROLLING CHARGING OF ELECTRONIC DEVICE, AND ELECTRONIC DEVICE AND CHARGING DEVICE SUPPORTING THE SAME

(71) Applicant: Samsung Electronics Co., Ltd., Suwon-si (KR)

(72) Inventors: Chulkwi KIM, Seoul (KR); Juyong KIM, Suwon-si (KR)

(73) Assignee: Samsung Electronics Co., Ltd., Suwon-si (KR)

(21) Appl. No.: 14/225,867

(22) Filed: Mar. 26, 2014

(30) Foreign Application Priority Data
Apr. 4, 2013 (KR) 10-2013-0036888

(51) Int. Cl. H02J 7/00

(52) U.S. Cl. CPC H02J 7/0052; H02J 7/0042
USPC 320/111; 320/137; 320/107

(57) ABSTRACT

A method for controlling a charging of an electronic device is provided. The method includes detecting a connection of a charging device, providing a connection control signal for the charging device, forming a communication channel with the charging device, and determining a charging power level based on the communication channel.

### CROSS-REFERENCE TO RELATED APPLICATION(S)

This application claims the benefit under 35 U.S.C. §119(a) of a Korean patent application filed on Apr. 4, 2013 in the Korean Intellectual Property Office and assigned Serial number 10-2013-0036888, the entire disclosure of which is hereby incorporated by reference.

### TECHNICAL FIELD

The present disclosure relates to electric power management of an electronic device. More particularly, the present disclosure relates to a battery charging device capable of charging batteries of varying capacities.

### BACKGROUND

Electronic devices use electric power and portable electronic devices use batteries for operation. A battery accumulates electric power for a duration of time and then supplies the power required for operating the electronic device. If the battery enters a low voltage state, the battery needs to be charged. The electronic devices are manufactured and sold in various forms. The capacity of a particular battery may vary according to the size of the battery, and a larger battery may provide a higher power capacity.

A charging device is provided for charging the battery, and may have different specifications according to the capacity of the battery to be charged. Therefore, an owner of a plurality of electronic devices must use a plurality of charging devices to charge the batteries, each battery having a different capacity.

Therefore, a need exists for a method and an apparatus for charging a plurality of batteries of varying capacities.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method for controlling an electronic device to improve a charging function of a battery, and the electronic device and a charging device supporting the same.

In accordance with an aspect of the present disclosure, a method for controlling a charging of an electronic device is provided. The method includes detecting a connection control signal for the charging device, providing a connection control signal for the charging device, forming a communication channel with the charging device, and determining a charging power level based on the communication channel.

In accordance with an aspect of the present disclosure, an electronic device is provided. The electronic device includes a connector configured to include a power supply terminal, a first connection terminal, a second connection terminal, and a ground terminal, a switch configured to be connected to the connector, a charging circuit and an application processor configured to be connected to the switch, and at least one charging control line configured to be disposed between the switch and the application processor.

In accordance with an aspect of the present disclosure, a charging device is provided. The charging device includes a plug, a power line configured to be connected to the plug, a power circuit configured to provide a specific level of power by transforming a power supplied by the power line, a charging connector configured to be connected to the power circuit and to include a power supply terminal, a first connection terminal, a second connection terminal, a short terminal for connecting the first and second connection terminals, and a ground terminal, and a detection line configured to provide the power circuit with a voltage by detecting the voltage formed at the short terminal.

In accordance with an aspect of the present disclosure, a charging device is provided. The charging device includes a plug, a power line configured to be connected to the plug, a power circuit configured to provide a specific level of power by transforming a power supplied by the power line, a charging connector configured to be connected to the power circuit and to include a power supply terminal, a first connection terminal, a second connection terminal, a power switch disposed between the first and second connection terminals, and a ground terminal, and a detection line configured to be disposed between the power switch and the power circuit.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic drawing illustrating a configuration of a charging system according to an embodiment of the present disclosure;

FIG. 2 is a block diagram illustrating a configuration of an electronic device and a charging device according to an embodiment of the present disclosure;

FIG. 3 is a block diagram illustrating a configuration of an electronic device and a charging device according to another embodiment of the present disclosure;

FIG. 4 is a signal flowchart illustrating a method for controlling a charging system according to an embodiment of the present disclosure;

FIG. 5 is a flowchart illustrating a method for controlling a charging of an electronic device according to an embodiment of the present disclosure; and

FIG. 6 is a drawing illustrating an example of a screen interface for supporting a charging control according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reasons, some components in the accompanying drawings are emphasized, omitted, or schematically illustrated, and the size of each component does not fully reflect the actual size. Therefore, the present disclosure is not limited to the relative sizes and distances illustrated in the accompanying drawings.

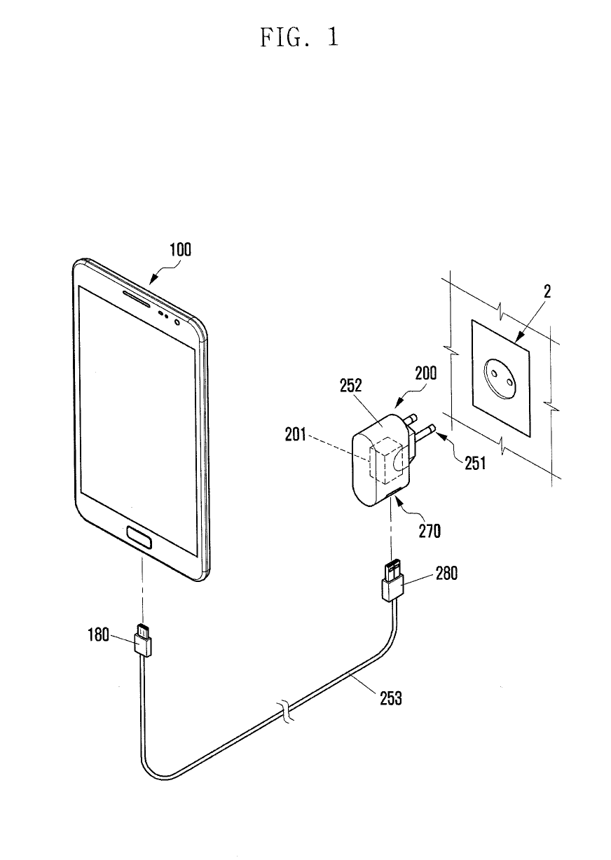

FIG. 1 is a schematic drawing illustrating a configuration of a charging system according to an embodiment of the present disclosure.

Referring to FIG. 1, the charging system according to the present disclosure may be configured with an electronic device 100 and a charging device 200.

In the charging system having the above configuration, if the charging device 200 is connected to the electronic device 100, the electronic device 100 identifies the type of the charging device 200. The electronic device 100 may request the charging device 200 to supply a threshold power amount by communicating with the charging device 200. Further, the electronic device 100 may perform a circuit setting so that the requested power amount can be processed. The charging device 200 transforms a voltage so as to be suitable for the power supply amount requested by the electronic device 100, and supplies the power of transformed voltage to the electronic device 100. For this, the electronic device 100 and the charging device 200 may include connectors for connecting each other.

In an embodiment, the electronic device 100 can process operations of device recognition, communication preparation, communication performance, and power supply, if the charging device 200 is connected. The electronic device 100 identifies the type of the charging device 200 while performing the above operations. If the charging device 200 is identified as a device providing a high voltage power, the electronic device 100 may request the charging device 200 for the high voltage power supply. For this, the electronic device 100 can transmit a control signal to the charging device 200. Further, the electronic device 100 can control a circuit setting so that the charging device 200 can process the high voltage power supply, and controls a battery charging by processing the power supplied from the charging device 200.

The charging device 200 may be configured with a plug 251, a case 252, a power circuit 201, and a cable 253. The plug 251 supplies power by connecting to a permanent electric power supply 2. The case 252 is configured to fix the plug 251 at a side and surrounds a power circuit 201. The power circuit 201 is disposed in the case 252. The cable 253 may be connected to the other side of the case 252 at which a charging connector 270 is provided for inserting a second connector 280 formed at an end of the cable 253.

The power circuit 201 disposed in the case 252 reduces a power voltage supplied by the permanent electric power supply 2 and supplies power to the electronic device 100. The power circuit 201 may reduce the power supplied by the permanent electric power supply 2 at various voltage levels. The power circuit 201 may reduce the power supplied by the permanent electric power supply 2 to a specific voltage level according to a request from the electronic device 100, and the power is transmitted through the cable 253.

The cable 253 connects the power circuit 201 to the electronic device 100. At an end of the cable 253, a first connector 180 for connecting to the electronic device 100 and a second connector 280 for connecting to the charging connector 270 formed at a side of the case 252 may be provided. For example, various types of connectors such as a Universal Serial Bus (USB) connector, a micro USB connector, and a Universal Asynchronous Receiver/Transmitter (UART) connector may be provided at an end of the cable 253. The first connector 180 may be formed in a micro USB connector and the second connector 280 may be formed in a USB connector. Alternatively, the second connector 280 may be formed not in a detachable type but in an integral type to the case 252. In this case, the second connector 280 and the charging connector 270 cannot be separated.

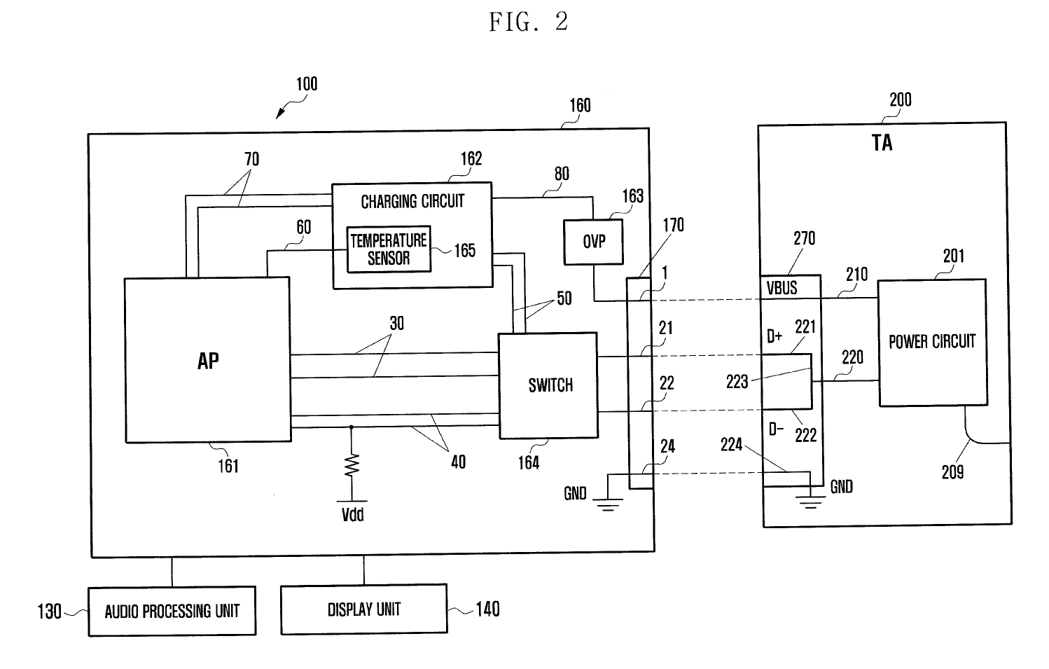

FIG. 2 is a block diagram illustrating a configuration of an electronic device and a charging device according to an embodiment of the present disclosure.

Referring to FIG. 2, the electronic device 100 according to the present disclosure may be configured with a control unit 160, a display unit 140, and an audio processing unit 130. FIG. 2 illustrates a partial configuration included in the electronic device 100 to explain components related to the charging control according to the present disclosure, and the electronic device 100 may further include various components. For example, the electronic device 100 may further include a communication unit for supporting a communication function and a storage unit for storing an operating system, and various contents and applications required for the operation of the electronic device 100. Further, the electronic device 100 may include various sensors such as an image sensor, an acceleration sensor, a proximity sensor, and an illumination sensor, for the operation of the electronic device 100. In the present disclosure, the electronic device 100 is illustrated to have only the audio processing unit 130, the display unit 140, and the control unit 160; however, the configuration of the electronic device 100 according to the present disclosure is not limited to this. The electronic device 100 according to the present disclosure includes the control unit 160 for a charging operation, and may include other components according to a designer's intention.

As shown in FIG. 2, the control unit 160 may include an application processor 161, a charging circuit 162, an Over-Voltage Protective (OVP) circuit 163, a switch 164, a temperature sensor 165, and a connector 170.

The connector 170 may include power supply terminals such as a VBUS terminal 1, a first connection terminal 21, a second connection terminal 22, and a ground terminal 24. The VBUS terminal 1 may be connected to a VBUS terminal 210 provided in the charging device 200 for the connection with the charging device 200. The first connection terminal 21 may be connected to a first connection terminal 221 provided in the charging device 200. The second connection terminal 22 may be connected to a second connection terminal 222 provided in the charging device 200. The ground terminal 24 may be connected to a ground terminal 224 provided in the charging device 200.

The OVPcircuit 163 is disposed between the VBUS terminal 1 and the charging circuit 162. The OVPcircuit 163 may protect the charging circuit 162 and components of the control unit 160 connected to the charging circuit 162 by breaking a power supplied through the VBUS terminal 1 when a power voltage is greater than a threshold value. A power supply line may be disposed between the OVPcircuit 163 and the charging circuit 162.

The charging circuit 162 receives a power supplied from the VBUS terminal 1 through the OVPcircuit 163. The charging circuit 162 may charge a battery (not shown) by using the supplied power. Further, the charging circuit 162 may supply a power for the operation of the electronic device 100. The temperature sensor 165 may be disposed in the charging circuit 162. A charge setting line 70 may be provided between the charging circuit 162 and the application processor 161 for the control of the charging circuit 162.

The temperature sensor 165 detects the temperature of the charging circuit 162. The temperature sensor 165 may provide detected temperature information for the application processor 161. A temperature transmission line 60 may be provided between the temperature sensor 165 and the application processor 161.

The switch 164 is connected to the first connection terminal 21 and the second connection terminal 22 provided in the connector 170. The switch 164 is connected to the charging circuit 162 and the application processor 161. If an external device connected to the connector 170 is a communication device, the switch 164 performs a switching operation for connecting or disconnecting the application processor 161 and the connector 170. Further, if an external device connected to the connector 170 is the charging device 200, the switch 164 may support to connect the application processor 161, charging circuit 162, and terminals of the connector 170. The switch 164 can perform a switching operation according to the control of the application processor 161. For the above operation, the switch 164 may include a charging signal line 50 connected to the charging circuit 162, a data signal line 30 connected to the application processor 161, and a charging control line 40. The data signal line 30 and the charging control line 40 may be configured respectively with 2 signal lines. A pull-up voltage Vdd may be applied to one of the signal lines of the charging control line 40.

The application processor 161 performs a data communication or a charging operation according to the type of the external device connected to the connector. The application processor 161 can identify the type of the external device connected to the connector 170 by using the first connection terminal 21 and the second connection terminal connected through the switch 164. The application processor 161 can identify a power supply capacity by performing a charging control communication if the external device is the charging device 200. Subsequently, the application processor 161 may request the charging device 200 for supplying a specific level of power. Further, the application processor 161 can change the settings of the charging circuit 162 so that the charging circuit 162 can process the specific level of power requested through the charge setting line 70.

The display unit 140 may output various screens related to the operation of the electronic device 100. For example, the display unit 140 may output information for guiding a connection of charging device 200 when connected to the connector 170 of the electronic device 100. Further, the display unit 140 may output an extent of charging with at least one of an image or a text while the charging device 200 is connected to charge a battery. The display unit 140 may output temperature information of the charging circuit 162 with an image or a text while charging the battery. When the temperature of the charging circuit 162 becomes higher than a threshold value, the display unit 140 may output an alarm image or a popup window. Further, the display unit 140 may output a power level supplied by the charging device 200. Further, the display unit 140 may output an estimated completion time of charging at the power level supplied by the charging device 200. The display unit 140 may output an alarm information if the power level of the charging device 200 is changed. Further, the display unit 140 may display various power levels supported by the charging device 200. A user may select a desired power level from the various power levels displayed in the display unit 140. For this, the display unit 140 may be provided with a touch screen to support a touch function.

The audio processing unit 130 may output an audio signal generated or collected while operating the electronic device 100. For this, the audio processing unit 130 may include a speaker for outputting an audio signal and a microphone for collecting an audio signal. The audio processing unit 130 may output an alarm sound or a guide sound when the charging device 200 is connected to the connector 170. Further, the audio processing unit 130 may output guide sounds for a full charging of battery and a battery charging state. Further, the audio processing unit 130 may output guide sounds for a power level change of the charging device 200 and the temperature of the charging circuit 162. The output of the guide sounds of the audio processing unit 130 can be disabled according to a user's setting or a designer's intention.

In the description of the electronic device 100, the application processor 161 and other components are shown to be directly connected through signal lines; however, the present disclosure is not limited to this. The components of the control unit 160 in the electronic device 100 may transmit a signal to the application processor 161 through an expansion port. For this, the control unit 160 may further include a General-Purpose Input/Output (GPIO) port.

The charging device 200 may include a first connector 180 and a second connector 280 formed respectively at an end of the power circuit 201 and an end of the cable 253, and a charging connector 270 into which the second connector 280 is to be inserted. These are only the related components required for explaining a charging operation by the components of the charging device 200.

The charging connector 270 may include a VBUS terminal 210, a first connection terminal 221, a second connection terminal 222, and a ground terminal 224. The charging connector 270 may further include a short line 223 connecting the first connection terminal and the second connection terminal 222. Accordingly, the first connection terminal 221 and the second connection terminal 222 of the charging connector 270 in the charging device 200 according to an embodiment of the present disclosure may be provided with a short circuit. As described above, when the charging device 200 is connected to the electronic device 100, each terminal of the charging connector 270 may be connected to each terminal of the connector 170 through the first connector 180 and the second connector 280 of the cable 253.

The power circuit 201 is connected to each terminal of the charging connector 270, and may supply a power received from the power line 209 through the plug 251 to the charging connector 270 of the electronic device 100 by transforming a voltage to a threshold level. In this process, the power circuit 201 may receive a pull-up voltage Vdd of the electronic device 100 as a connection control signal if the charging device 200 is connected to the electronic device 100. If the pull-up voltage Vdd corresponding to the connection control signal is received from the electronic device 100, the power circuit 201 may prepare a charging control communication with the electronic device 100. Subsequently, the power circuit 201 may decide a power level according to the charging control signal received from the electronic device 100. The power circuit 201 may then supply a charging power corresponding to the decided power level to the electronic device 100 through the charging connector 270.

A power circuit communication line 220 may be disposed between the power circuit 201 and the short line 223. A voltage applied to the power circuit communication line may be transmitted to the power circuit 201. Accordingly, the power circuit 201 may prepare a communication for the charging control connection by detecting a change of voltage applied to the power circuit communication line 220, and may receive a signal transmitted by the electronic device 100 through the power circuit communication line 220.

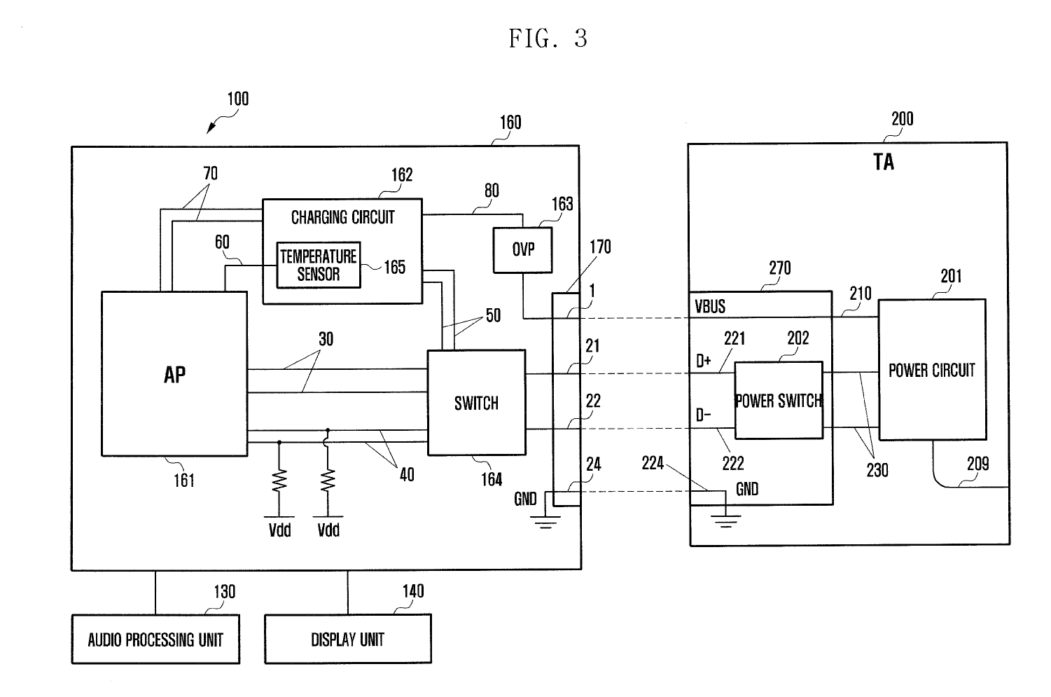

FIG. 3 is a block diagram illustrating a configuration of an electronic device and a charging device according to another embodiment of the present disclosure.

Referring to FIG. 3, the charging system according to the present disclosure may include an electronic device 100 and a charging device 200. The charging system having the above configuration may be provided with a 2-way communication between the electronic device 100 and the charging device 200.

In an embodiment, the control unit 160 of the electronic device 100 may include an application processor 161, a charging circuit 162,—an OVPcircuit 163, a switch 164, and a connector 170. The control unit 160 of the electronic device 100 may be provided in the same configuration of the control unit 160 shown in FIG. 2, except that a pull-up voltage Vdd is applied to each charging control line 40 provided between the application processor 161 and the switch 164. Further, the display unit 140 and audio processing unit 130 of the electronic device 100 may have the same configuration as that of FIG. 2.

The charging device 200 may include a power circuit 201 and a charging connector 270. The charging device 200 according to another embodiment of the present disclosure further includes a power switch 202 disposed between the first connection terminal 221 and the second connection terminal 222.

The power switch 202 may perform an operation of connecting or disconnecting the first connection terminal and the second connection terminal according to the control of the power circuit 201. For example, the power switch 202 may maintain the first connection terminal 221 and the second connection terminal 222 in a closed state according to the type of electronic device 100 being connected under the control of the power circuit 201. In an embodiment, if the electronic device 100 requests for a charging control connection, the power switch 202 may maintain the first connection terminal 221 and the second connection terminal 222 in an open state. If the electronic device 100 requests for a charging control connection, the switch 164 may maintain the first connection terminal 221 and the second connection terminal 222 in a closed state.

A power circuit communication line 230 may be disposed between the power switch 202 and the power circuit 201. A plurality of power circuit communication lines 230 may be disposed between the power switch 202 and the power circuit 201. Accordingly, the power circuit 201 can perform a 2-wire communication with the application processor 161 through the power circuit communication line 230, the power switch 202, the first connection terminal 221, the second connection terminal 222, the first connection terminal 21, the second connection terminal 22, the switch 164, and the charging control line 40. The power circuit 201 and the application processor 161 may transmit or receive a signal through two signal paths.

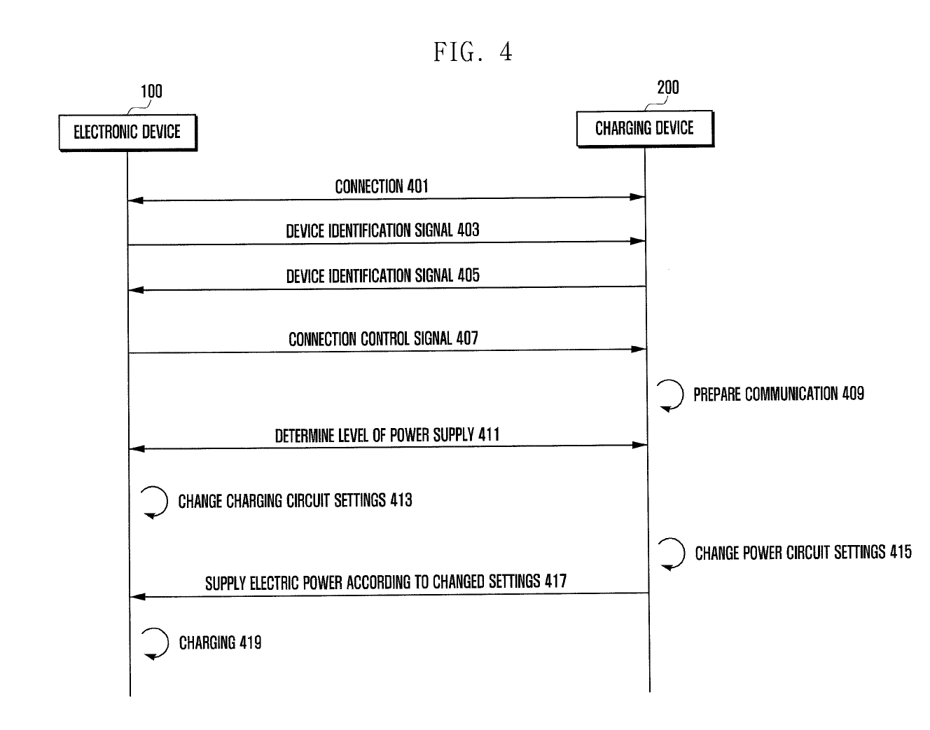

FIG. 4 is a signal flowchart illustrating a method for controlling a charging system according to an embodiment of the present disclosure.

Referring to FIG. 4, the method for controlling a charging according to the present disclosure starts with connecting the electronic device 100 and the charging device 200 at operation 401. For this, the charging connector 270 disposed at an end of the cable 253 of the charging device 200 is connected to the connector 170 of the electronic device 100.

If the charging connector 270 of the charging device 200 is connected to the connector 170 of the electronic device 100, the electronic device 100 transmits a device identification signal to the charging device 200 at operation 403. For example, the electronic device 100 may transmit a device identification signal corresponding to a threshold voltage level to at least one of the first connection terminal 21 and the second connection terminal 22. Because the first connection terminal 221 and the second connection terminal 222 are closed, if the electronic device 100 transmits the device identification signal at operation 403, the charging device 200 transmits a signal identical to the received device identification signal to the electronic device 100 at operation 405. In an embodiment, the device identification signal transmitted by the electronic device 100 is returned through the short circuit of the charging device 200 without any signal converting. The electronic device 100 can decide that the external device is a charging device 200, if the device identification signal transmitted according to a routine at operation 403 is returned from the charging device 200.

For the above operation, the electronic device 100 may control the switch 164 to connect the connector 170 and the charging circuit 162. In particular, the electronic device 100 may control the switch 164 to connect the first connection terminal 21 and the second connection terminal 22 of the connector 170 to the charging signal line 50 of the charging circuit 162. The application processor 161 can control the charging circuit 162 through the charging control line 40 connected to the charging circuit 162. In particular, if an external device is connected to the connector 170, the application processor 161 may control the charging circuit 162 to transmit a signal of threshold voltage level to at least one of the first connection terminal 21 and the second connection terminal 22, and accordingly collect and provide a feedback signal. The application processor 161 decides that the connected external device is a charging device if a received device identification signal is identical to the transmitted device identification signal, and controls the switch 164 to directly connect the connector 170 and the application processor 161. Accordingly, the first connection terminal 21 and the second connection terminal 22 can be connected to the application processor 161 through the switch 164 and the charging control line 40.

The electronic device 100 then transmits a connection control signal to the charging device 200 at operation 407. The connection control signal transmitted to the charging device 200 may be a specific signal generated by the application processor 161. Alternatively, a pull-up voltage Vdd may be applied to at least one signal line of the charging control lines 40 as shown in FIGS. 2 and 3. If the switch 164 forms a signal path including the charging control line 40 and the pull-up voltage Vdd is transmitted to the second connection terminal 222 through the switch 164 and the second connection terminal 22, the pull-up voltage transmitted to the second connection terminal 222 increases the voltage level of the first connection terminal 221 and the second connection terminal 222 to the pull-up voltage level. While the power circuit 201 of the charging device 200 detects a voltage formed at the power switch 202 or on the short line 223 through the power circuit communication line 220 or 230, if the corresponding voltage is increased to the pull-up voltage Vdd, the power circuit receives it as a connection control signal.

If the connection control signal is received from the electronic device 100, the power circuit 201 prepares a communication at operation 409. For example, the power circuit 201 may wait in a state of preparing to receive a specific signal from the electronic device 100.

In an embodiment, the electronic device 100 determines with the charging device 200 in order to use a specific level of power supply at operation 411. For this, the electronic device 100 may transmit a signal requesting for a power supply of the specific level to the connected charging device 200. Further, the electronic device 100 changes the settings of the charging circuit 162 at operation 413. In an embodiment, the electronic device 100 can change the settings of the charging circuit 162 so that the power level requested to the charging device 200 can be processed. If the charging circuit 162 is already set to the power level requested to the charging device 200, the change of the settings can be omitted. If a request for a specific level of power supply is received from the electronic device 100, the charging device 200 changes the settings of the power circuit 201 at operation 415. For example, if the electronic device 100 requests for a power supply of a 12V/4 A level, the charging device 200 correspondingly supplies the power of the 12V/4 A level by changing the settings of the power circuit 201. Further, if the electronic device 100 requests for a power supply of a 9V/2 A level, the charging device 200 changes the settings of the power circuit 201 so that a power of the corresponding level can be supplied

If the settings of the power circuit 201 are changed, the charging device 200 supplies a power according to the changed settings at operation 417. The power circuit 201 transmits a power according to the changed settings through the VBUS terminal 210, and the power is transmitted to the charging circuit 162 through the VBUS terminal 1, the OVPcircuit 163, and the power supply line 80.

The charging circuit 162 of the electronic device 100 controls a battery charging operation by using the supplied power at operation 419. The charging circuit 162 may supply a portion of the power for the operation of the electronic device 100.

If a higher level of power supply is required as the battery is being charged or according to the operation of electronic device 100, the electronic device 100 may transmit a signal for changing the power level to the charging device 200 through the charging control line 40, the switch 164, the first connection terminal 21, and the second connection terminal 22. If the power level of the first connection terminal 221 and the second connection terminal 222 connected to the first connection terminal 21 and the second connection terminal 22 is changed, the power circuit 201 of the charging device 200 identifies it as a power level change signal, and accordingly changes the power level and adjusts the power supply.

If the charging device 200 includes a power switch 202 as shown in FIG. 3, the power switch 202 may maintain the first connection terminal 221 and the second connection terminal 222 in a closed state. If a connection control signal is received from the electronic device 100, the power circuit 201 controls the power switch 202 to cut off the connection of the first connection terminal 221 and the second connection terminal 222. Accordingly, the power circuit 201 can utilize the first connection terminal 221 and the second connection terminal 222 respectively as a transmission line and a reception line for the charging control signal. For example, the power circuit 201 may use the first connection terminal 221 as a reception line for a signal transmitted by the electronic device 100, and the second connection terminal 222 as a transmission line for a signal to be transmitted to the electronic device 100. Further, the power circuit 201 may exchange a signal related to the charging control by using the power circuit communication lines 230 connected respectively to the first connection terminal 221 and the second connection terminal 222.

If the charging device connected to the connector 170 is a device unable to change a power level (i.e., if the device provides only one power level), the electronic device 100 may perform a charging without the determination. For example, a normal charging device cannot transmit a specific response signal to the electronic device 100 by responding to the connection control signal at operation 407, even though the connection control signal is transmitted. Accordingly, the electronic device 100 identifies the charging device as a normal charging device if no effective signal is received, and proceeds with the charging by using the power provided by the charging device.

As described above, the charging system according to the present disclosure can provide various charging conditions according to the characteristics of the charging device 200 connected to the connector 170, and thereby an improved charging operation is supported. For example, the charging system according to the present disclosure determines a charging level by communicating with the charging device 200 supporting various power levels, and provides an optimum level of power according to a state of the electronic device 100. Further, the charging system according to the present disclosure can support various power levels according to a user's request.

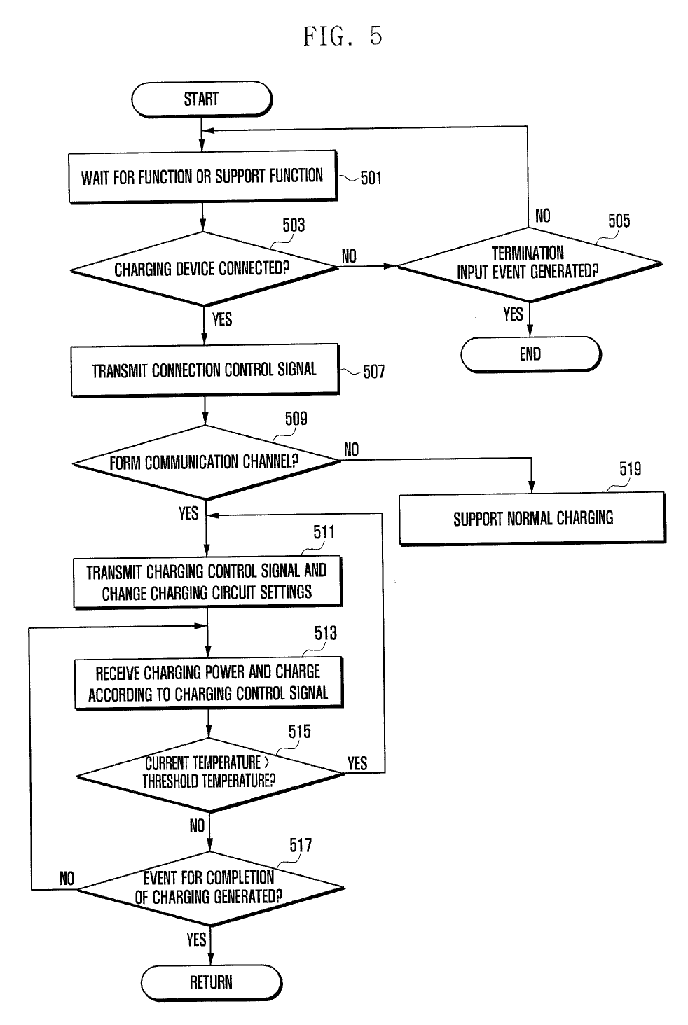

FIG. 5 is a flowchart illustrating a method for controlling a charging of an electronic device according to an embodiment of the present disclosure.

Referring to FIG. 5, the method for controlling a charging of an electronic device according to the present disclosure firstly waits for a function or supports the function at operation 501. At the operation of waiting for a function or supporting the function, the electronic device 100 may output a waiting screen or a menu screen, or maintain a sleep state. Alternatively, the electronic device 100 may support a specific application requested by a user.

The electronic device 100 may be in a turn-off state at operation 501. However, the electronic device 100 may be designed to operate a charging circuit even in the turn-off state. In an embodiment, the electronic device 100 may be designed to use a minimum routine of the application processor 161 for a charging control, if the charging device 200 is connected to the electronic device 100 in the turn-off state. For this, the electronic device 100 may be designed to use a certain routine of the application processor 161 to enable a battery charging control even in the turn-off state. Some circuits of the electronic device 100 are designed to identify a connection of the charging device 200 when the charging device 200 is connected to the connector 170 of the electronic device 100. The charging circuit 162 as corresponding circuits identifies whether the charging device 200 is a determinable device for a charging level, and may request the application processor 161 to use some circuits for the charging control.

Subsequently, the connection of the charging device 200 is identified at operation 503. If the connection of the charging device 200 is not identified at this operation, the procedure goes to operation 505 to identify whether an input event for terminating the electronic device 100 is generated. If the input event is not generated at this operation, the procedure returns to the operation 501 and re-performs the following operations.

If a charging device is connected at operation 503, the electronic device 100 controls to transmit a connection control signal to the charging device 200 at operation 507. As described above, the operation 503 may be performed by changing a pull-up voltage in a specific circuit of the electronic device 100 (i.e., a circuit applied by the pull-up voltage) when the charging device 200 is connected to the connector 170 of the electronic device 100. The operation 507 may be performed by transmitting a pull-up voltage applied on the charging control line 40 disposed between the application processor 161 and the switch 164 to the charging device 200 as a connection control signal. The sizes of the pull-up voltage and the connection control signal for identifying the connection of the charging device 200 may be designed identically or differently. Alternatively, the charging system may be designed so that the application processor 161 transmits a connection control signal to the charging device 200 through the charging control line 40 without applying a pull-up voltage to the charging control line 40.

Subsequently, the electronic device 100 identifies whether a communication channel is formed at operation 509. The identification of the communication channel by the electronic device 100 may be designed in various forms. For example, when the charging device 200 receives a connection control signal and prepares a communication, the charging device 200 may inform the preparation of communication to the electronic device 100. The electronic device 100 can then identify formation of a communication channel with the charging device 200 based on the signal of communication preparation transmitted by the charging device 200.

Alternatively, the application processor 161 of the electronic device 100 may transmit a confirmation request signal to the charging device 200 through the charging control line 40 if the charging device 200 is connected. If the power circuit 201 of the charging device 200 transmits a response signal to the electronic device 100, the electronic device 100 can identify the formation of a communication channel with the charging device 200. If the charging device 200 is a normal charging device having a short circuit between the first connection terminal 221 and the second connection terminal 222, the communication channel is not formed. If the communication is not formed at operation 509, the electronic device 100 returns to operation 519 and supports a normal charging.

If the communication channel is formed at operation 509, the electronic device 100 goes to operation 511, and transmits a charging control signal and changes charging circuit settings. Subsequently, the electronic device 100 performs a charging operation by receiving a charging power according to the charging control signal at operation 513.

The electronic device 100 may transmit a request signal for a power supply of a specific level set as default to the charging device 200. In an embodiment, the electronic device 100 may change the settings of the charging circuit 162 so that a specific level of power can be processed. If the specific level of power is supplied from the charging device 200, the electronic device 100 may proceed with battery charging accordingly. Further, the electronic device 100 may support to use the supplied power for the operation of the electronic device 100.

The electronic device 100 may identify a residual power amount of the battery, decide an optimum power level, and transmit a request signal for a power supply of the corresponding level to the charging device 200. If the battery is in a low voltage state (for example, residual power amount 10%) and a quick charging is required, the electronic device 100 may request the charging device 200 for a power supply at the highest level or relatively higher level. If the residual power amount of the battery is greater than a threshold value (for example, 70%), the electronic device 100 may request the charging device 200 for a power supply at a second level. Further, if the residual power amount of the battery is 90%, the electronic device 100 may request the charging device 200 for a power supply at the lowest level or at a relatively lower level (for example, first level).

For example, if the charging device 200 supports changes of power levels from 5V to 20V, a designer of the charging device 200 and the electronic device 100 may allocate a level 1, level 2, level 3, level 4, and level 5 respectively to 5V, 9V, 12V, 15V, and 20V. The electronic device 100 may identify a chargeable voltage for the battery and a power level suitable for the current residual power amount of the battery, and request the charging device 200 for a power supply of the corresponding level. If the maximum chargeable voltage of the battery of the electronic device 100 is 12V and a quick charging is required, the electronic device 100 may request the charging device 200 for a power supply of the level 3. In an embodiment, the electronic device 100 may decide the power level from chargeable voltages, and request the charging device 200 for a proper power supply.

From the point of view of the charging device 200, if the electronic device 100 providing a connection control signal is connected, the charging device 200 may prepare a communication and change the settings of the power circuit 201 so that a power requested by the electronic device 100 can be supplied. Accordingly, the charging device 200 may supply a specific level of power to the electronic device 100 according to the changed settings of the power circuit 201. If an electronic device supporting no connection control signal is connected, the charging device 200 may maintain or change the settings of the power circuit 201 for a normal charging so that a specific level (for example, level 1) of power is supplied to the electronic device 100.

The electronic device 100 compares the current temperature of the charging circuit 162 with a threshold temperature at operation 515, and thereby may identify whether the current temperature is higher than the threshold temperature. If the current temperature is lower than the threshold temperature, the electronic device 100 goes to operation 511 and re-performs the following operations. For this, a temperature sensor 165 may be disposed in the charging circuit 162. Information detected by the temperature sensor 165 may be periodically transmitted to the application processor 161. If the current temperature of the charging circuit 162 is higher than the threshold temperature, the electronic device 100 may identify at operation 517 whether an event for completion of the charging is generated. The event for completion of the charging may be generated if the current temperature becomes higher than the threshold temperature. If the event for completion of the charging is generated, the application processor 161 may request the charging device 200 to cut off the power supply through the charging control line 40. The charging device 200 may cut off the power supply according to a request from the electronic device 100. If the event for completion of the charging is generated, the electronic device 100 may terminate the charging and return to a specific operating state of the electronic device 100. For example, the electronic device 100 may return to operation 501, and control to wait for a function, perform a specific function, or maintain a turn-off state.

If the event for completion of the charging is not generated at operation 517, the electronic device 100 goes to operation 513 and re-performs the following operations. In an embodiment, if the current temperature of the charging circuit 162 is higher than the threshold temperature but the charging is required to be continued, the electronic device 100 may transmit a signal for changing the power level to the charging device 200. The electronic device 100 then goes to operation 513 and performs a charging operation by receiving a power of the level changed according to the charging control signal from the charging device 200.

The control operation of the electronic device 100 according to the temperature (i.e., operation 515) may be optional and omitted according to a designer's intention.

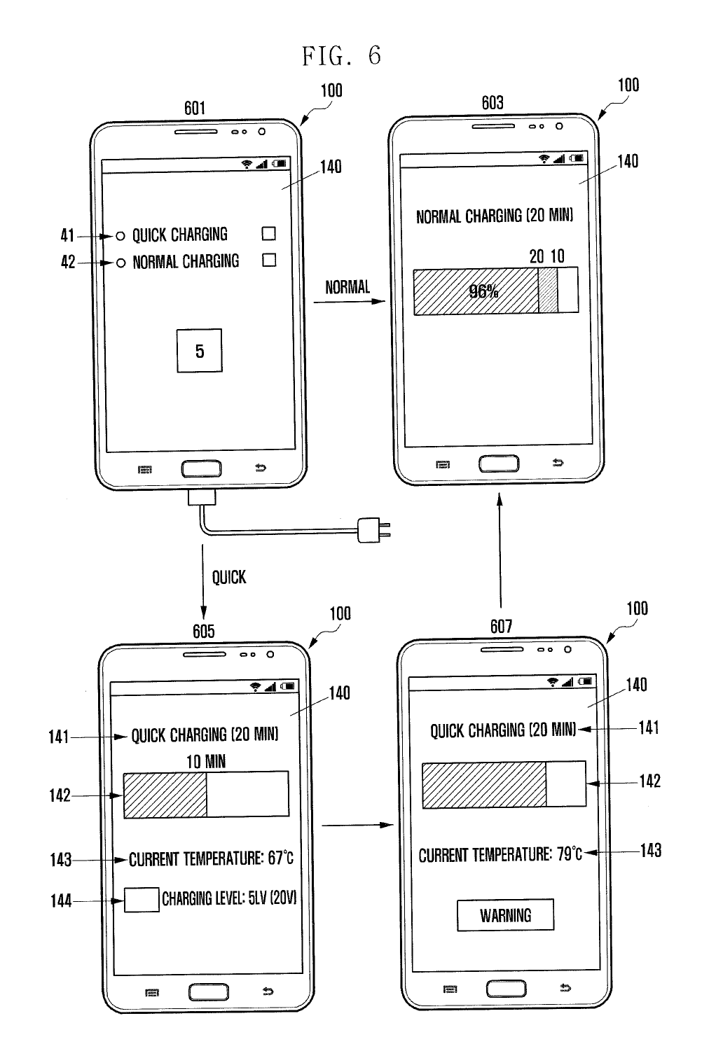

FIG. 6 is a drawing illustrating an example of a screen interface for supporting a charging control according to an embodiment of the present disclosure.

Referring to FIG. 6, if the charging device 200 according to the present disclosure is connected to the connector 170 (not shown) of the electronic device 100, the display unit 140 of the electronic device 100 may output a charging mode selection screen for selecting a quick charging mode selection item 41 or a normal charging mode selection item 42 as shown by screen 601. If the charging device connected to the connector 170 of charging device supporting only a single level of power supply, the charging mode selection screen may be omitted. Further, the display unit 140 of the electronic device 100 may display items for selecting various sizes of voltages by subdividing the quick charging mode selection item 41. In an embodiment, the quick charging mode selection item 41 may be provided to support a plurality of charging mode selection items according to various sizes of voltage. The display unit 140 of the electronic device 100 may display the charging mode selection screen for a threshold time. For guiding the threshold time, the display unit 140 may output countdown information at a side of the screen.

If a selection input is not received for the threshold time, the control unit 160 may select a default charging mode and perform a charging according to the corresponding charging mode. For example, the control unit 160 may select the quick charging mode as default and request for a power supply of the maximum voltage level to charge a battery. Alternatively, the control unit 160 may select the normal charging mode as default and request for a power supply of a basic voltage provided by the charging device 200. The basic voltage is a voltage set as default by the charging device 200 and, for example, may be 5V. In an embodiment, the charging mode selection screen may be re-displayed in the display unit 140 according to a user's request. For this, the electronic device 100 may provide the charging mode selection items as a menu or icons.

If the normal charging mode selection item 42 is selected in the screen 601, the electronic device 100 may output a charging screen according to the normal charging periodically, temporarily, or continuously to the display unit 140 as shown by screen 603. Alternatively, the electronic device 100 may go into a sleep mode after temporarily outputting the normal charging screen. If an event for disabling the sleep mode is generated, the display unit 140 may temporarily output the normal charging screen.

If the quick charging mode selection item 41 is selected from the screen 601, the electronic device 100 may output a screen corresponding the quick charging to the display unit 140 as shown by screen 605. The quick charging mode screen may include guide information 141 indicating a quick charging, total quick charging time information 142, current temperature information 143 of the electronic device 100, and charging level information 144.

The guide information 141 may be information for guiding that the quick charging mode is operating. The guide information 141 may include a time required for the quick charging. The quick charging time information 142 may include an image indicating the time required for the quick charging and an image indicating a time elapsed for the quick charging. The quick charging time information 142 may be displayed in a charging ratio.

The current temperature information 143 of the electronic device 100 may be temperature information of the charging circuit 162 detected by the temperature sensor 165 disposed in the charging circuit 162. The current temperature information 143 may include limited temperature information. The limited temperature may be information notifying a generation time of a charging completion event. The charging level information 144 may be information indicating a power level used for a charging according to the selection of the quick charging mode. The charging level information 144 may vary according to the size of chargeable voltage. Further, the charging level information 144 may vary according to a residual power amount of a battery. The charging level information 144 may be used for changing the charging level according to a user's decision. The charging level information 144 may include linked items for changing the charging level. If a linked item is selected, the display unit 140 may switch to a charging level change screen or output a popup window.

If the quick charging is performed as shown by screen 605, the quick charging time information 142 may display a variable charging amount corresponding to the quick charging as shown by screen 607. In an embodiment, the electronic device 100 may output an alarm if the current temperature is higher than a threshold temperature. The electronic device 100 may control to automatically switch to the normal charging mode after outputting the alarm. Alternatively, the electronic device 100 may output a menu after outputting the alarm so that a user can change the charging level. Further, the electronic device 100 may determine with the charging device 200 to lower the charging level after outputting the alarm.

The electronic device 100 may operate the quick charging mode as default without providing a function of selecting a charging mode. In this case, the output of screens 601 and 603 may be omitted. Further, the electronic device 100 may not provide a menu or an icon for the selection of the charging mode. The electronic device 100 may simply output an alarm and maintain the previous state of charging power control. In an embodiment, the electronic device 100 may maintain the quick charging state without performing another charging power control.

The charging device 200 of the charging system according to the present disclosure may include at least one indication lamp. The charging device 200 may light a specific lamp from a plurality of lamps or a specific color lamp according to the level of charging. Alternatively, the charging device 200 may include a display unit to output information related to the charging level. The charging device 200 may output a residual time to a charging completion or a residual power amount of a battery.

In the aforementioned description, an example of providing a charging control line 40 for the communication between the electronic device 100 and the charging device 200 has been described, however the present disclosure is not limited to this. In an embodiment, the electronic device 100 may use the data signal line 30 for controlling the charging. The application processor 161 of the electronic device 100 may transmit a connection control signal to the charging device 200 through the data signal line 30, if the charging device 200 is connected. Further, the electronic device 100 may transmit a charging control signal to the charging device 200 through the data signal line 30.

The electronic device 100 may include various additional modules according to the specification of the electronic device. In an embodiment, if the electronic device 100 is a communication terminal, the electronic device 100 may further include components not listed above, such as a local area network communication module, interface for transmitting data corresponding to a wired or wireless communication method of the electronic device 100, internet communication module for performing an internet function, and digital broadcast module for receiving and playing a digital broadcasting. Such components have many variations according to the digital convergence trend, and thereby all the available components cannot be listed here. However, components having an equal level to the aforementioned components may be further included in the electronic device 100. Further, the electronic device 100 according to the present disclosure may be configured by excluding or replacing specific components according to the specification of the device. This will be apparent to those skilled in the art.

Further the electronic device 100 according to various embodiments of the present disclosure may include mobile communication terminals operating by communication protocols corresponding to various communication systems, and data communication equipment and multimedia equipment such as a Portable Multimedia Player (PMP), digital broadcast player, Personal Digital Assistant (PDA), music player (for example, MP3 player), portable game terminal, smart phone, notebook, and hand-held Personal Computer (PC).

As described above, the present disclosure provides a method for controlling a charging of an electronic device, and the electronic device and charging device which enable to charge a high capacity battery with a high speed. Further, the present disclosure enables to charge various batteries having different capacities with one charging device.

At this point it should be noted that the exemplary embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the exemplary embodiments of the present invention as described above. Alternatively, one or more processors operating in accordance with stored instructions may implement the functions associated with the exemplary embodiments of the present invention as described above. If such is the case, it is within the scope of the present disclosure that such instructions may be stored on one or more processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present invention can be easily construed by programmers skilled in the art to which the present invention pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for controlling a charging of an electronic device, the method comprising:
detecting a connection of a charging device;
providing a connection control signal for the charging device;
forming a communication channel with the charging device; and
determining a charging power level based on the communication channel.

2. The method of claim 1, wherein the detecting connection of the charging device determines an external device is the charging device when a signal received from the external device is identical to a signal transmitted to the external device.

3. The method of claim 1, wherein the providing of the connection control comprises one of:
providing a pull-up voltage as a connection control signal for the charging device; and
providing a connection control signal for the charging device.

4. The method of claim 1, wherein the determining of the charging power level comprises:
identifying a chargeable voltage of a battery and transmitting a charging control signal corresponding to the identified chargeable voltage to the charging device.

5. The method of claim 4, further comprising:
changing a setting of a charging circuit for the battery to an electric power level corresponding to the charging control signal transmitted to the charging device.

6. The method of claim 1, further comprising:
outputting a screen including a plurality of charging mode selection items when the electronic device forms the communication channel.

7. The method of claim 1, further comprising:
outputting charging level information corresponding to the determined charging power level.

8. An electronic device, comprising:
a connector configured to include a power supply terminal, a first connection terminal, a second connection terminal, and a ground terminal;
a switch configured to be connected to the connector;
a charging circuit and an application processor configured to be connected to the switch; and
at least one charging control line configured to be disposed between the switch and the application processor.

9. The electronic device of claim 8, further comprising:
a pull-up voltage connected to at least one line of the at least one charging control lines.

10. The electronic device of claim 8, wherein the application processor is configured to form a communication channel with the charging device by transmitting a signal for detecting a device when an external device is connected and to provide a connection control signal if the external device is a charging device.

11. The electronic device of claim 10, wherein the application processor is configured to provide a charging control signal for the charging device in order to determine a charging power level through the communication channel.

12. The electronic device of claim 10, further comprising:
a temperature sensor configured to be disposed in the charging circuit,
wherein the application processor is configured to control to terminate the charging or to transmit a charging control signal in order to request a changing of a charging power level if a temperature detected by the temperature sensor is higher than a threshold temperature.

13. The electronic device of claim 10, further comprising:
a display unit configured to output a screen including a plurality of charging mode selection items when the communication channel is formed.

14. The electronic device of claim 13, wherein the display unit outputs one of charging mode guide information, quick charging time information and charging level information corresponding to a selected charging mode.

15. A charging device, comprising:
a plug;
a power line configured to be connected to the plug;
a power circuit configured to provide a specific level of power by transforming a power supplied by the power line;
a charging connector configured to be connected to the power circuit and to include a power supply terminal, a first connection terminal, a second connection terminal, a short terminal for connecting the first and second connection terminals, and a ground terminal; and
a detection line configured to provide the power circuit with a voltage by detecting the voltage formed at the short terminal.

16. The charging device of claim 15, wherein the power circuit performs a preparation for communication if a threshold voltage is formed at the short terminal.

17. The charging device of claim 15, wherein the power circuit is configured to perform a setting change to supply a power of a specific level according to a charging control signal received through the short terminal.

18. A charging device, comprising:
a plug;
a power line configured to be connected to the plug;
a power circuit configured to provide a specific level of power by transforming a power supplied by the power line;
a charging connector configured to be connected to the power circuit and to include a power supply terminal, a first connection terminal, a second connection terminal, a power switch disposed between the first and second connection terminals, and a ground terminal; and
a detection line configured to be disposed between the power switch and the power circuit.

19. The charging device of claim 18, wherein the power circuit is configured to control the power switch to maintain the first and second connection terminals in a short-circuited state, and to disconnect the first and second connection terminals and to connect the first and second connection terminals to each detection line if a threshold voltage is formed between the first and second connection terminals.

20. The charging device of claim 19, wherein the power circuit performs a setting change to supply a power of a specific level according to a charging control signal received through the detection line.
